(19) United States
(12) Patent Application Publication
(10) Pub. No.: US 2004/0239955 A1
(43) Pub. Date: Dec. 2, 2004

(54) Print job creation apparatus and print job creation method

(76) Inventors: Yasuhiko Uchida, Nagano-ken (JP); Hiroyasu Tamagawa, Nagano-ken (JP); Satoru Momose, Nagano-ken (JP); Kazunori Shimoda, Nagano-ken (JP)

Correspondence Address: MARTINE & PENILLA, LLP, 710 LAKEWAY DRIVE, SUITE 170, SUNNYVALE, CA, 94085, US

(21) Appl. No.: 10/800,261

(22) Filed: Mar. 11, 2004

(30) Foreign Application Priority Data
Mar. 12, 2003 (JP) 2003-066823

(51) Int. Cl. G06F 15/00

(52) U.S. Cl. 358/1.1; 358/1.15

(57) ABSTRACT

A print job creation process includes a print service selection step, an image registration step, a template selection step, a layout editing step, and a print step. A template selection window, which is open in the template selection step, has a checkbox ‘Use Print Image Matching 2/Exif Print’ to set execution or non-execution of printing with shooting information. In the case of setting execution of the printing with shooting information, part of image editing options are restricted in the layout editing step. This arrangement readily creates a print job, while effectively preventing high-quality printing with shooting information from being damaged by editing the image.

### BACKGROUND OF THE INVENTION

1. Field of the Invention

The present invention relates to a print job creation apparatus and a print job creation method. More specifically the invention pertains to a print job creation apparatus that creates print jobs and a corresponding print job creation method.

2. Description of the Prior Art

Proposed print job creation apparatuses edit a specified image and create a print job to print the edited image. One example of such print job creation apparatuses is a general computer with installation of an application software program ‘Digital Camera de!! Doji Print (Simultaneous Printing with Digital Camera) 6’ manufactured by A. I. Soft. Inc. This software has editing functions of modifying an image in a selected shooting mode, finely adjusting the lightness and the contrast, changing the color to monochromatic or sepia, and applying filter effects on the image (see Non-Patent Cited Reference 1 given below).

Image matching techniques of a digital camera with a printer have also been proposed for high-definition printing of photograph images. For example, the PIM (Print Image Matching: registered trademark by Seiko Epson Corporation) technique described in Non-Patent Cited Reference 2 and Non-Patent Cited Reference 3 given below specifies settings of a color space, contrast, color balance, saturation, and a shooting mode at the time of shooting photographs with a digital camera, adds the specified settings in the form of commands to photograph image data obtained by shooting, and causes a printer to print resulting images according to such commands. This aims at printing of optimum color shape. The ‘Exif Print’ (Exchangeable Image File Format Print: formulated by Japan Electronics and Information Technology Industries Association (JEITA)) standard described in Non-Patent Cited Reference 4 given below stores diverse attribute information with regard to shooting conditions in addition to image data taken with a digital camera in the form of image files and prints resulting images according to the attribute information. This aims at high-quality printing.

In the prior art print job creation apparatus, each image is freely editable. Some editing process may thus interfere with high-quality printing with the shooting information.

Non-Patent Cited Reference 1

‘Digital Camera de!! Doji Print (Simultaneous Printing with Digital Camera) 6, User's Manual, 1^{st} ed. A. I. Soft. Inc., July 2002, p 70-97

Non-Patent Cited Reference 2

Seiko Epson Corporation ‘Your photographs taken by a digital camera will be printed faithfully.’ [retrieved on Feb. 25, 2003], the Internet <URL: http://www.i-love-epson.co.jp/products/pim/pim2-info.htm>

Non-Patent Cited Reference 3

Seiko Epson Corporation ‘Print Image Matching Optimum for Printing of Images taken with Digital Camera’ [retrieved on Feb. 25, 2003], the Internet <URL: http://www.i-love-epson.co.jp/products/printer/inkjet/pim/pim1/htm>

Non-Paten Cited Reference 4

Camera & Imaging Products Association ‘Exif Print’ [retrieved on Feb. 25, 2003] the Internet <URL:http://www.cipa.jp/exifprint/contents_i/01exif_i.html>

### SUMMARY OF THE INVENTION

The print job creation apparatus and the print job creation method of the invention aim to readily create a print job for high-quality printing. The print job creation apparatus and the print job creation method of the invention also aim to readily create a print job for high-quality printing with information set at the time of shooting an image.

In order to attain at least part of the above and the other related objects, the present invention is directed to a print job creation apparatus and a corresponding print job creation method constructed as discussed below.

A print job creation apparatus of the invention is an apparatus that creates a print job, and the apparatus includes: an image acquisition module that acquires an image, which is involved in a print job; a shooting information-based print setting module that sets either execution or non-execution of shooting information-based printing, which represents printing with shooting information set at a time of shooting an image; and an editing execution module that executes editing in response to an operator's operation under restrictions on a predetermined editing item among available editing items of the image involved in the print job in the case of setting execution of the shooting information-based printing by the shooting information-based print setting module, and with permission to all the available editing items of the image involved in the print job, which include the predetermined editing item, in the case of setting non-execution of the shooting information-based printing by the shooting information-based print setting module.

The print job creation apparatus of the invention executes editing in response to the operator's operation under restrictions on the predetermined editing item among available editing items of the acquired image involved in the print job, in the case of setting execution of the shooting information-based printing, which represents printing with shooting information set at a time of shooting an image. Such restrictions desirably prevent high-quality printing of an image with the shooting information from being damaged by subsequent editing of the image. This arrangement thus readily creates a print job for high-quality printing with shooting information set at the time of shooting an image. The print job creation apparatus executes editing in response to the operator's operation with permission to all the available editing items of the acquired image involved in the print job, which include the predetermined editing item, in the case of setting non-execution of the shooting information-based printing. The image is thus subjected to the desired editing. This arrangement readily creates a print job for high-quality printing.

In the print job creation apparatus of the invention, the shooting information-based print setting module may set execution or non-execution of the shooting information-based printing in the course of selecting a template used for printing, and the shooting information may include at least part of specification of a color space, setting of contrast, setting of saturation, setting of color balance, and setting of a shooting mode in both a shooting device and in a printing device.

Further, in the print job creation apparatus of the invention, the shooting information-based print setting module may set execution or non-execution of printing in conformity with PIM ‘Print Image Matching’ as the shooting information-based printing, and may set execution or non-execution of printing in conformity with Exif Print ‘Exchangeable image file format Print’ as the shooting information-based printing.

Moreover, in the print job creation apparatus of the invention, the predetermined editing item may include at least part of contour softening/sharpening, setting of lightness, setting of contrast, color change, change to sepia/monochromatic, and application of a cross filter.

In one preferable application, the print job creation apparatus of the invention may include a print service setting module that sets one print service selected among multiple print service options, in response to the operator's operation. In this case, the multiple print services may include at least one of an enlargement printing service, a digest printing service, a calendar printing service, a postcard printing service, a photo name card printing service, an ID photograph printing service, a seal printing service, a label printing service, and an album printing service.

In another preferable application, the print job creation apparatus of the invention may further include a printing condition setting module that sets a printing condition of the print job, in response to the operator's operation.

The technique of the invention is not restricted to the print job creation apparatus but is also actualized by a print job creation method that creates print jobs.

### BRIEF DESCRIPTION OF THE DRAWINGS

FIG. 1 schematically illustrates the configuration of a print job management system 10;

FIG. 2 shows an example of menu window 60;

FIG. 3 is a flowchart showing a print job creation routine;

FIG. 4 shows an example of image registration window 70;

FIG. 5 shows an example of template selection window 80;

FIG. 6 shows an example of layout editing window 90;

FIG. 7 is a flowchart showing an editing management routine; and

FIG. 8 shows an example of print window 100.

### DESCRIPTION OF THE PREFERRED EMBODIMENTS

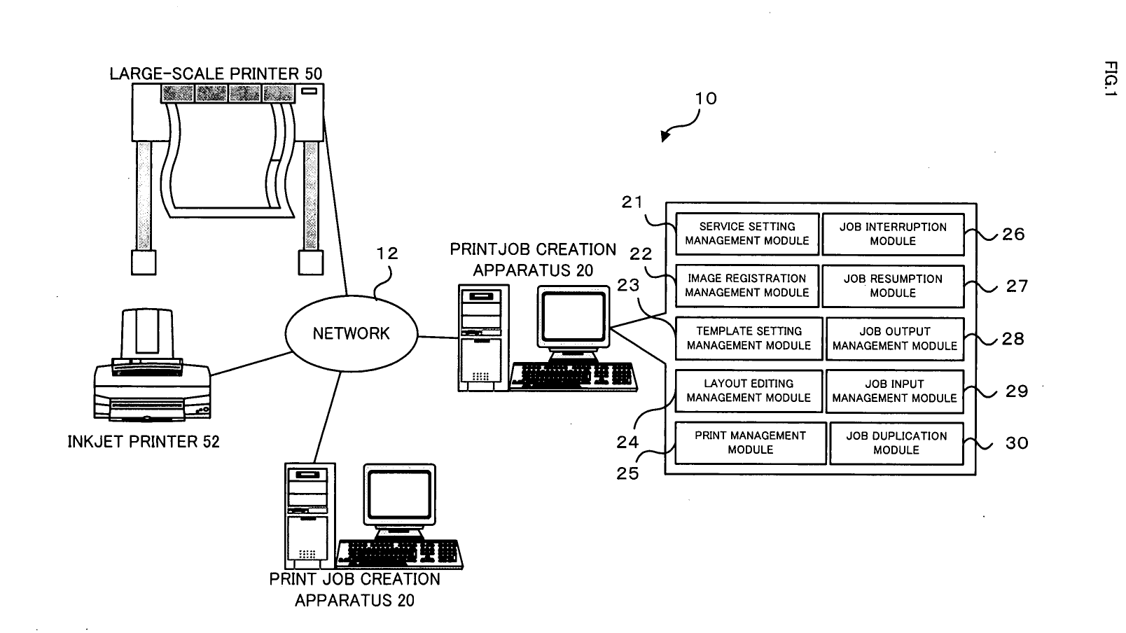

A preferred embodiment of the invention is discussed below. FIG. 1 schematically illustrates the configuration of a print job management system 10 including print job creation apparatuses 20 in one embodiment of the invention. The print job management system 10 of the embodiment includes multiple print job creation apparatuses 20 to create print jobs, a large-scale printer 50, and an inkjet printer 52, which are connected via a network 12.

The print job creation apparatuses 20 of the embodiment is constructed as a general computer, in which a non-illustrated print job creation program as application software and support data including template images used for printing are installed. Execution of the print job creation program causes the computer to function as the print job creation apparatus. The print job creation apparatus 20 of the embodiment creates print jobs as various print services including creation of calendars and creation of postcards and gives instructions of executing such print jobs. As shown in FIG. 1, the print job creation apparatus 20 has, as its functional blocks, a service setting management module 21 that accepts settings of a service selected among various print services to create a print job, an image registration management module 22 that manages registration of one or multiple images used for each print job, a template setting management module 23 that manages settings of a template used for each print job, a layout editing management module 24 that manages adjustment of a layout of images and editing of images, and a print management module 25 that manages printing. The print job creation apparatus 20 also includes a job interruption module 26 that interrupts creation of a print job in the middle, a job resumption module 27 that resumes creation of a print job, which has been interrupted in the middle of its creation (hereafter referred to as print job under creation), a job output management module 28 that manages output of each print job under creation, a job input management module 29 that manages input of each print job under creation, and a job duplication module 30 that duplicates a print job under creation or an executed print job to create a new print job. Due to limitations of space, only two print job creation apparatuses 20 are connected with the network 12 in the illustration of FIG. 1. In the actual state, however, three or more print job creation apparatuses 20 may be connected with the network 12. The detailed operations of the print job creation apparatus 20 will be discussed later.

The large-scale printer 50 is capable of high-quality color printing to a size Al, while the inkjet printer 52 is capable of high-quality color printing to a size A4. Due to limitations of space, there are only two printers, that is, the large-scale printer 50 and the inkjet printer 52, connected to the network 12 in the illustration of FIG. 1. In the actual state, however, three or more printers of an identical type or different types may be connected to the network 12.

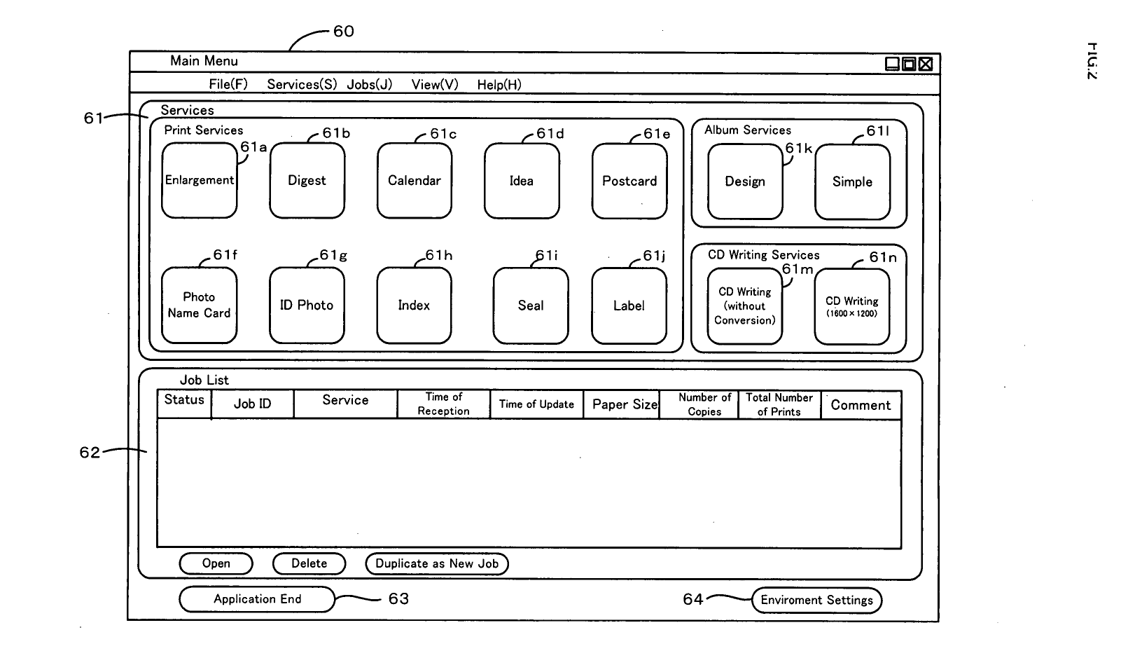

The following describes the operations of the print job creation apparatus 20 of the embodiment constructed as discussed above. FIG. 2 shows an example of menu window 60 open on the display of the print job creation apparatus 20 on startup of the non-illustrated print job creation program as the application software. The menu window 60 of FIG. 2 has a service selection field 61 for selecting a desired print service and a job list field 62 for displaying a list of print jobs. The service selection field 61 includes various selection buttons for print services, album services, and CD writing services. The buttons for print services include an ‘Enlargement’ button 61a to print an image in a large size, a ‘Digest’ button 61b to print multiple images as a digest, a ‘Calendar’ button 61c to print a calendar with images, an ‘Idea’ button 61d to print an image with any of templates of various designs, a ‘Postcard’ button 61e to print an image on a postcard, a ‘Photo Name Card’ button 61f to print name cards with a photograph, an ‘ID Photo’ button 61g to print an ID photograph, an ‘Index’ button 61h to print an index of a large number of images, a ‘Seal’ button 61i to create seals with an image, and a ‘Label’ button 61j to create labels for CDs and DVDs. The buttons for album services include a ‘Design’ button 61k to create an album with any of templates of various designs and a ‘Simple’ button 61l to create an album with a simple template. The buttons for CD writing services include a ‘CD Writing (without Conversion)’ button 61m to write an image into a CD without any conversion and a ‘CD Writing (1600×1200)’ button 61n to alter the size of an image to 1600×1200 and write the image of the altered size into a CD. The status, the job ID, the selected service, the time of reception, the time of update, the paper size, the number of copies, the total number of prints, and the comment with regard to respective print jobs under creation are listed in the job list field 62. The display of print jobs under creation and the job list field 62 will be discussed later. The menu window 60 also has an ‘Application End’ button 63 and an ‘Environment Settings’ button 64 which are both located below the job list field 62.

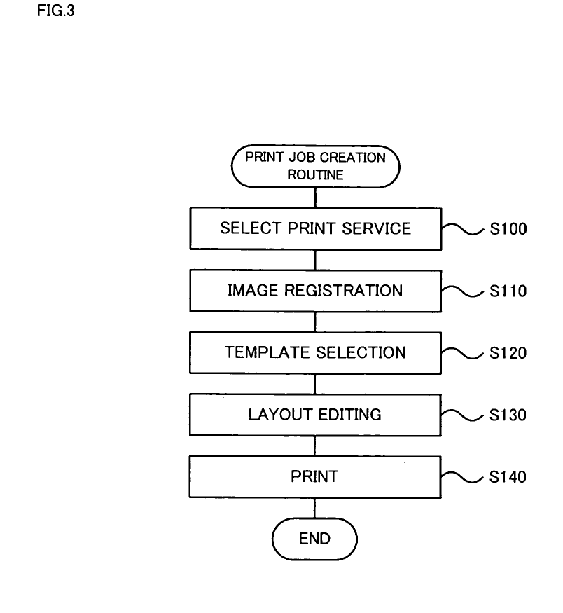

The print job creation apparatus 20 of the embodiment creates a print job according to a print job creation routine shown in FIG. 3. The print job creation routine first receives selection of a desired print service (step S100). The user clicks one of the available service buttons 61a through 61n in the service selection field 61 of the menu window 60 to select a desired print service. The service setting management module 21 of the print job creation apparatus 20 manages display of the menu window 60, acceptance of selection of a service, and start of creation of a print job in the selected service.

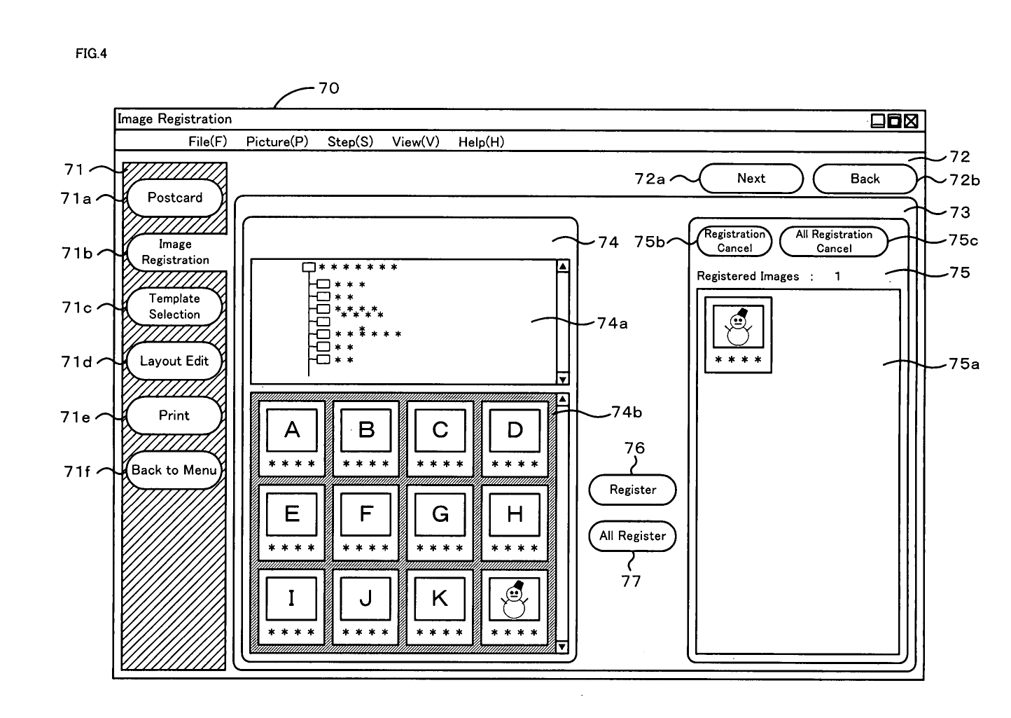

In response to selection of a desired print service, the print job creation apparatus 20 of the embodiment opens an image registration window 70 shown in FIG. 4 and executes an image registration step to register images used for the selected print service (step S110). In the illustrated example of FIG. 4, the image registration window 70 has a process display field 71 to display a print job creation process and an image registration dialog box 72 to register selected images. The process display field 71 includes a ‘Selected Service Display’ button 71 to display a selected print service, an ‘Image Registration’ button 71b, a ‘Template Selection’ button 71c, a ‘Layout Edit’ button 71d, and a ‘Print’ button 71e showing steps in the print job creation process, and a ‘Back to Menu’ button 71f to interrupt creation of a current print job and go back to the menu window 60. The image registration dialog box 72 is displayed in connection with the ‘Image Registration’ button 71b and is open when the print job creation process is at the image registration step.

The image registration dialog box 72 has a work field 73, which includes an image selection field 74 to receive the user's selection of a storage place (a directory or a folder), in which images are stored, and display a list of thumbnails and file names of images stored in the selected storage place and a registered image display field 75 to display a list of thumbnails and file names of registered images. The work field 73 also has a ‘Register’ button 76 to register an image selected in the image selection field 74 and display the registered image in the registered image display field 75 and an ‘All Register’ button 77 to register all the images displayed in the image selection field 74 and display all the registered images in the registered image display field 75. The user selects a desired image storage place in a storage place display field 74a of the image selection field 74, selects a desired image among images displayed in an image display field 74b of the image selection field 74 in response to selection of the storage place (that is, among images stored in the selected storage place), and clicks the ‘Register’ button 76. The desired image is accordingly registered and displayed in an image display field 75a of the registered image display field 75. The registered image display field 75 also has a ‘Registration Cancel’ button 75b to cancel registration of an image selected in the image display field 75a and an ‘All Registration Cancel’ button 75c to cancel registration of all registered images. The image registration dialog box 72 also has a Next’ button 72a to terminate the image registration step and to go to a next step in the print job creation process and a ‘Back’ button 72b to go back to a previous step in the print job creation process. A click of the ‘Back’ button 72b in the image registration window 70 terminates the image registration step and reopens the menu window 60. The ‘Back’ button 72b accordingly has the same function as that of the ‘Back to Menu’ button 71f. The image registration management module 22 of the print job creation apparatus 20 manages this image registration step.

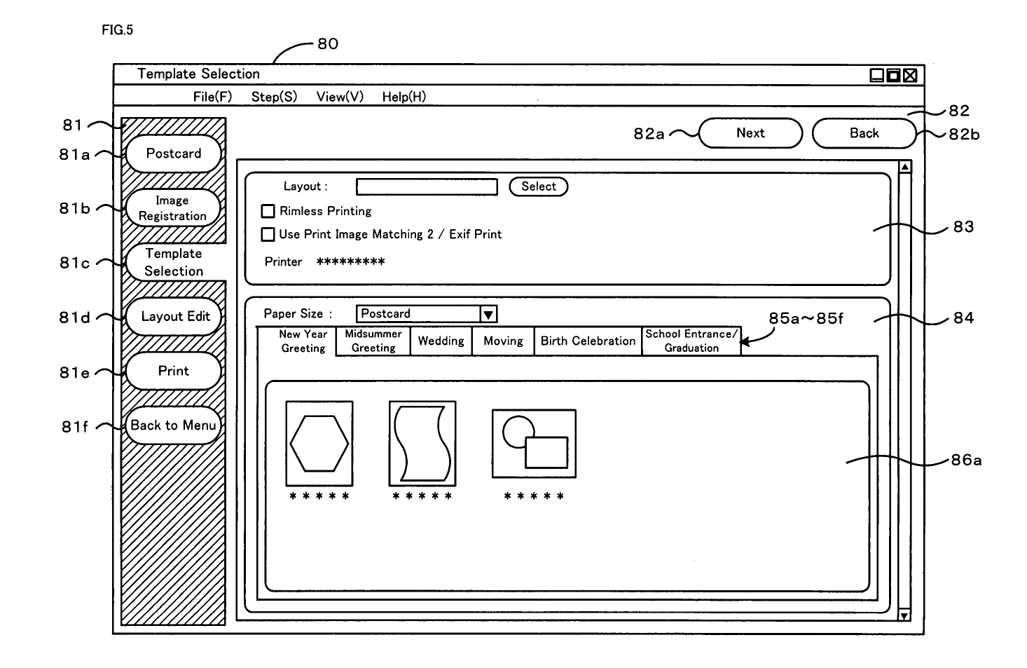

In response to a click of the ‘Next’ button 72a after registration of one or multiple desired images, the print job creation routine opens a template selection window 80 shown in FIG. 5 and executes a template selection step to select a desired template, in which the registered image is inserted (step S120). In the illustrated example of FIG. 5, the template selection window 80 includes a process display field 81, which is identical with the process display field 71 of the image registration window 70 shown in FIG. 4, and a template selection dialog box 82 to select a desired template. In this template selection window 80, the template selection dialog box 82 is displayed in connection with a ‘Template Selection’ button 81c in the process display field 81 and is open when the print job creation process is at the template selection step.

The template selection dialog box 82 has a setting field 83 to specify settings of a template and a template selection field 84 to select a desired template. The setting field 83 includes a layout input box for direct entry of a layout used as a template, a checkbox to set rimless printing, and a checkbox to effectuate image matching of a digital camera with a printer using ‘Print Image Matching 2’ and ‘Exif Print’. Here ‘Print Image Matching 2’ is a standard proposed by Seiko Epson Corporation. This technique specifies settings of a color space, contrast, color balance, saturation, and a shooting mode at the time of shooting photographs with a digital camera, adds the specified settings in the form of commands to photograph image data obtained by shooting, and causes a printer to print resulting images according to such commands. This aims at printing of optimum color shape. ‘Print Image Matching’ is the registered trademark by Seiko Epson Corporation. ‘Exif Print (Exchangeable Image File Format Print)’ is a standard formulated by Japan Electronics and Information Technology Industries Association (JEITA). This technique stores diverse attribute information with regard to shooting conditions in addition to image data taken with a digital camera in the form of image files and prints resulting images according to the attribute information. This aims at high-quality printing. Printing in the mode of effectuating ‘Print Image Matching 2’ or ‘Exif Print’ utilizes information including the settings of the digital camera at the time of shooting. In the description of the embodiment below, such printing is referred to as printing with shooting information.

The template selection field 84 has tags 85a through 85f corresponding to available template types. The respective tags 85a through 85f have template display fields 86a through 86f to display a list of thumbnails and file names of available templates. The user selects a desired tag among the tags 85a through 85f and selects a desired template among templates displayed in the template display field of the selected tag. In response to selection of the desired template, the selected file name is shown in the layout input box of the setting field 83. The template selection field 84 also has a paper size input box to select a desired paper size. The template selection dialog box 82 has a ‘Next’ button 82a to go to a next step and a ‘Back’ button 82b to go back to a previous step, like the image registration dialog box 72. A click of the ‘Back’ button 82b in the template selection window 80 reopens the image registration window 70, and the processing goes back to the previous step, that is, the image registration step (step S110) in the print job creation process. The template setting management module 23 of the print job creation apparatus 20 manages this template selection step.

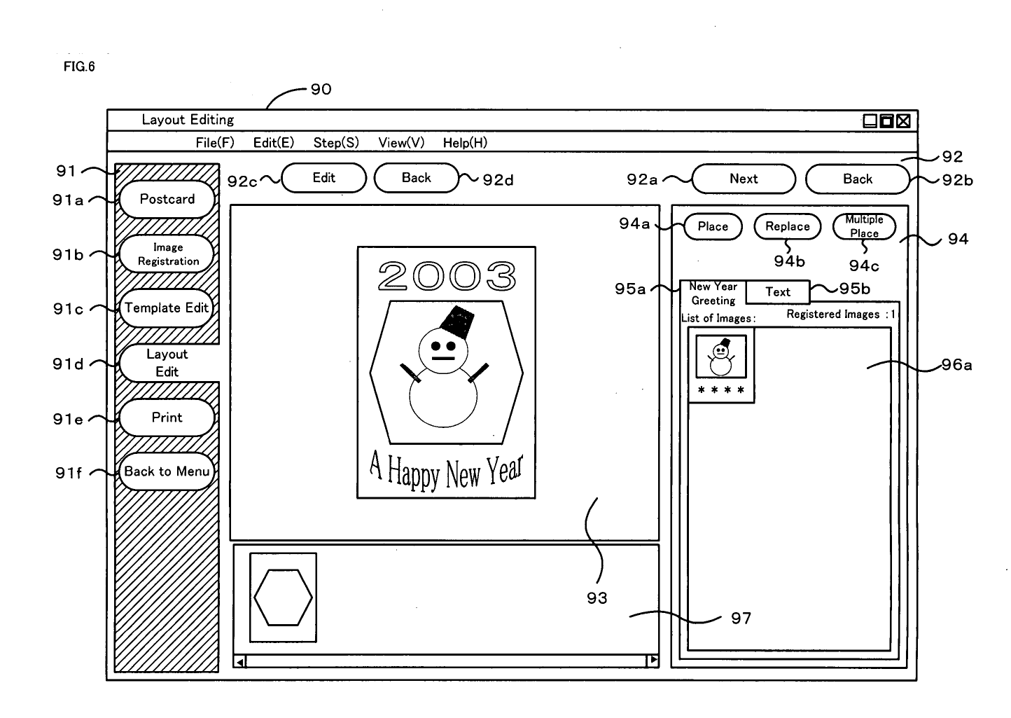

In response to a click of the ‘Next’ button 82a after selection of the desired template, the print job creation routine opens a layout editing window 90 shown in FIG. 6 and executes a layout editing step to adjust a layout of images and edit the images (step S130). In the illustrated example of FIG. 6, the layout editing window 90 includes a process display field 91, which is identical with the process display fields 71 and 81 in the image registration window 70 of FIG. 4 and in the template selection window 80 of FIG. 5, and a layout editing dialog box 92 to layout and edit the images. In this layout editing window 90, the layout editing dialog box 92 is displayed in connection with a ‘Layout Edit’ button 91d in the process display field 91 and is open when the print job creation process is at the layout editing step.

The layout editing dialog box 92 includes a layout editing field 93 to combine the selected template with a registered image and thereby layout and edit the image, an image selection field 94 to select an image to be combined with the selected template, and a thumbnail display field 97 to display the thumbnail of the selected template. The image selection field 94 has a tag 95a for selecting a registered image and a tag 95b for writing a text. The tag 95a has an image display field 96a to display a list of registered images and their file names. The tag 95b has a text input box for entry of a desired text, although not being specifically illustrated. The image selection field 94 also has a ‘Place’ button 94a to place a selected image in the template displayed in the layout editing field 93, a ‘Replace’ button 94b to replace the selected image with an image currently placed in the template in the layout editing field 93, and a ‘Multiple Place’ button 94c to place the selected image in multiple areas of the template. The user may select a desired image among the images displayed in the image display field 96a of the tag 95a and click the ‘Place’ button 94a. This places the selected image in a specified area of the template. The user may select a desired image among the images displayed in the image display field 96a of the tag 95a and click the ‘Replace’ button 94b, while an image has already been placed in a specified area of the template in the layout editing field 93. This replaces the newly selected image with the current image in the specified area of the template. The user may select a desired image among the images displayed in the image display field 96a of the tag 95a and click the ‘Multiple Place’ button 94c. This places the selected image in multiple specified areas of the template. The layout editing dialog box 92 has a ‘Next’ button 92a to go to a next step and a ‘Back’ button 92b to go back to a previous step, like the image registration window 70 and the template selection window 80. The layout editing dialog box 92 also has an ‘Edit’ button 92c to edit the image combined with the template displayed in the layout editing field 93 and a ‘Display Magnification’ button 92d to change a display magnification in the layout editing field 93. When the user selects the image combined with the template displayed in the layout editing field 93 and clicks the ‘Edit’ button 92c, a pulldown menu is open to select a desired specification of editing among various options including rotation, frame rotation, vertical or horizontal inversion, trimming, die cutting, contour softening/sharpening, settings of lightness and contrast, color change, change to sepia/monochromatic, cross filter, red eye reduction, cloning, and auto correction. The output editing management module 24 of the print job creation apparatus 20 manages this layout editing step.

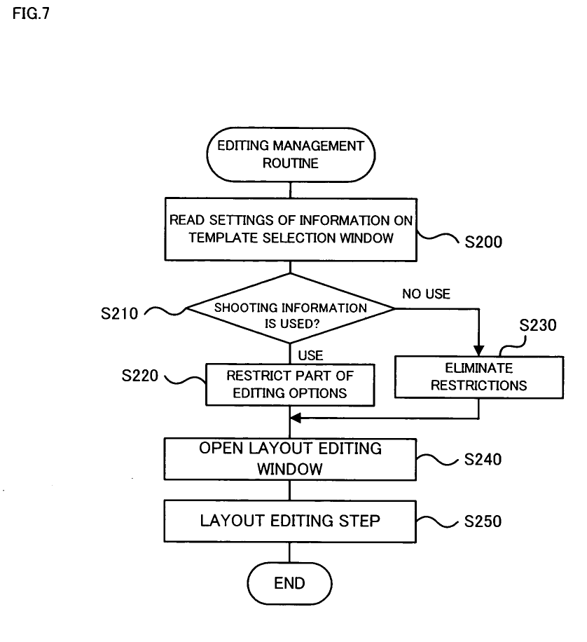

While a check mark is entered in the checkbox to effectuate image matching of a digital camera with a printer using the ‘Print Image Matching 2’ and ‘Exif Print’ standards in the template selection window 80 of FIG. 5, the user may click the ‘Next’ button 82a to activate the layout editing management module 24 for management of the layout editing step. This state restricts part of editing options executable when the user selects a desired image combined with the selected template in the layout editing field 93 and clicks the ‘Edit’ button 92c. The procedure of this embodiment prohibits the following editing options: trimming, die cutting, contour softening/sharpening, settings of lightness and contrast, color change, change to sepia/monochromatic, cross filter, red eye reduction, cloning, and auto correction. Such restrictions desirably prevent the high-quality printing in conformity with the ‘Print Image Matching 2’ standard or the ‘Exif Print’ standard from being damaged by editing of the image. This restriction process follows an editing management routine shown in the flowchart of FIG. 7. The editing management routine first reads the settings of the information on the template selection window 80 (step S200) and determines, based on the read-out settings of the information, whether printing in conformity with the ‘Print Image Matching 2’ standard or the ‘Exif Print’ standard, that is, printing with shooting information, is to be executed (step S210). The determination depends upon the presence or the absence of the check mark in the checkbox ‘Use Print Image Matching 2/Exif Print’ in the setting field 83 on the template selection window 80. When it is determined that the printing with shooting information is to be executed, the routine places restrictions on editing to prohibit the specified editing options, that is, trimming, die cutting, contour softening/sharpening, settings of lightness and contrast, color change, change to sepia/monochromatic, cross filter, red eye reduction, cloning, and auto correction (step S220), opens the layout editing window 90 (step S240), and starts the layout editing step (step S250). When it is determined that the printing with shooting information is not to be executed, on the other hand, the routine eliminates restrictions on editing (step S230), opens the layout editing window 90 (step S240), and starts the layout editing step (step S250). In the editing-restricted state, the restricted options among the editing options included in the pulldown menu, which is open in response to a click of the ‘Edit’ button 92c, are displayed pale to be non-selectable. Elimination of the restrictions on editing makes all the editing options included in the pulldown menu displayed clear to be selectable.

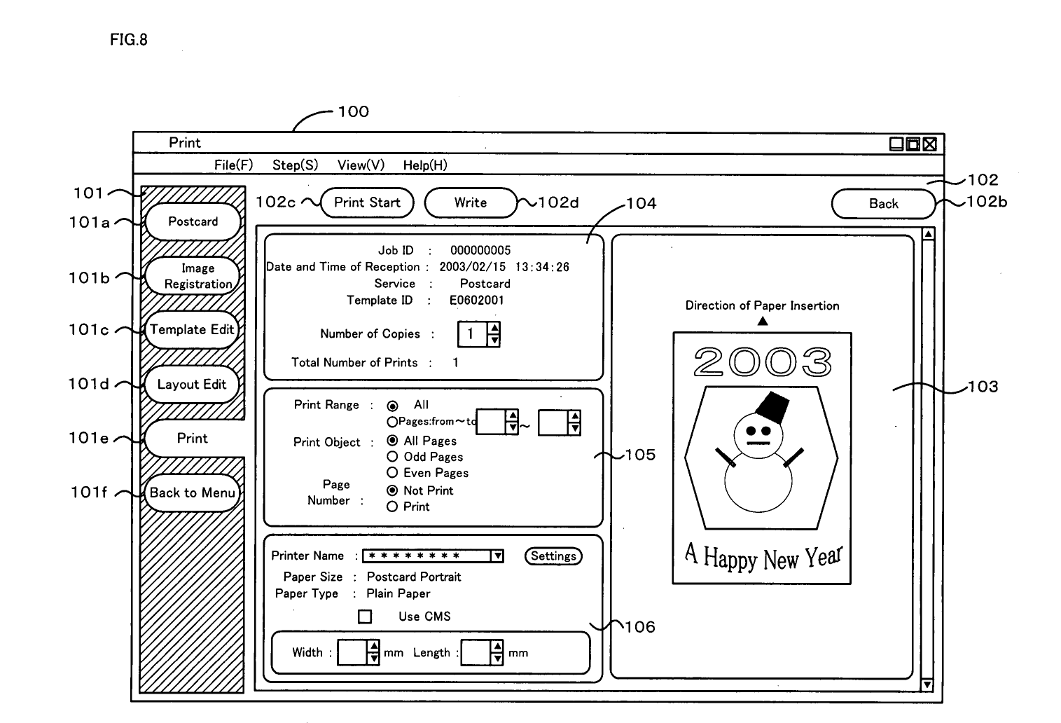

In response to a click of the ‘Next’ button 92a after layout of the image in the selected template and desired editing in the layout editing window 90, the print job creation routine opens a print window 100 shown in FIG. 8 and executes a print step to specify various settings for printing and execute printing (step S140). In the illustrated example of FIG. 8, the print window 100 includes a process display field 101, which is identical with the process display fields 71, 81, and 91 of the image registration window 70, the template selection window 80, and the layout editing window 90, and a print dialog box 102 to specify settings for printing and give a print execution instruction. In this print window 100, the print dialog box 102 is displayed in connection with a ‘Print’ button 101e in the process display field 101 and is open when the print job creation process is at the print step.

The print dialog box 102 has a printed image display field 103 to display a resulting image to be printed, which has been set in the template and gone through layout and editing, a job information display field 104 to display information regarding the print job, a printing condition setting field 105 to set printing conditions, and a printer setting field 106 to specify settings of the printer. The job information display field 104 shows the job ID, the date and time of reception, the service, and the template ID as information regarding the print job, and has a copy number input box to selectively enter a desired number of copies. The printing condition setting field 105 has radio buttons and an input box for setting a print range, radio buttons for setting a print object, and radio buttons for selecting either printing or non-printing of page numbers. The printer setting field 106 has a printer selection box to select a printer to be used for printing, a check box to select either application or non-application of color management system (CMS), and an area input box for setting a printing area. The printer setting field 106 also shows the settings of the paper size and the paper type in the selected printer. The printer selection box in the printer setting field 106 shows the printer set in advance corresponding to the selected combination of the print service and the paper size in the environment settings process as a default printer. When the check mark is present in the checkbox ‘Use Print Image Matching 2/Exif Print’ on the template selection window 80 shown in FIG. 5, a check mark is automatically entered in the checkbox of color management system (CMS) in the printer setting field 106 on the print window 100. This informs the user of execution of the printing with the color management system, that is, the printing with shooting information.

The print dialog box 102 also has a ‘Back’ button 102b to go back to a previous step, a ‘Print Start’ button 102c to give a print execution instruction, and a ‘Write’ button 102d to write a resulting image file into a desired directory or folder, instead of printing. The print job creation process executed by the print job creation apparatus 20 of the embodiment terminates in response to a click of the ‘Print Start’ button 102c or in response to a click of the ‘Write’ button 102d. The click of the ‘Print Start’ button 102c or the ‘Write’ button 102d starts execution of the created print job. After execution of printing with the selected printer or writing of a processed image file in response to a click of the ‘Print Start’ button 102c or the ‘Write’ button 102d, the display is returned to the menu window 60 for subsequent selection of a desired print service. When the check mark is present in the checkbox ‘Use Print Image Matching 2/Exif Print’ on the template selection window 80 shown in FIG. 5, the commands added as the shooting information to the image data are transmitted to the selected printer, which then prints a resulting image with the transmitted shooting information. The print job creation routine of FIG. 3 terminates at this stage, prior to the click of the ‘Print Start’ button 102c or the ‘Write’ button 102d. The print management module 25 of the print job creation apparatus 20 of the embodiment manages this print step.

In the print job creation apparatus 20 of the embodiment, the job interruption module 26 functions to interrupt creation of a print job in the middle, while the job resumption module 27 functions to resume interrupted creation of the print job. The job output management module 28 functions to store a print job under interrupted creation in the form of a file into an external storage device, such as a hard disk unit, or to send the file to another print job creation apparatus 20. The job input management module 29 functions to input a print job under creation in the form of a file. The job duplication module 30 functions to duplicate a print job under creation or an executed print job and start creation of a new print job of an identical print service or a different print service. The series of processing executed by the job interruption module 26, the job resumption module 27, the job output management module 28, the job input management module 29, and the job duplication module 30 are not essential for the present invention. No further explanation is thus given here.

As described above, in the print job creation apparatus 20 of the embodiment, when the check mark is present in the checkbox ‘Use Print Image Matching 2/Exif Print’ in the setting field 83 on the template selection window 80, part of the image editing options are restricted on the layout editing window 90. This arrangement effectively prevents the high-quality printing in conformity with the ‘Print Image Matching 2’ standard or the ‘Exif Print’ standard from being damaged by editing of the image. Namely the print job creation apparatus 20 of the embodiment creates a print job for high-quality printing with shooting information. The printing with shooting information is readily executable by simply entering a check mark in the checkbox ‘Use Print Image Matching 2/Exif Print’ on the template selection window 80, which is open to specify the settings of a desired template.

In the print job creation apparatus 20 of the embodiment, the image registration management module 22 that manages registration of each image on the image registration window 70 corresponds to the image acquisition module of the invention. The template setting management module 23 that manages selection of a desired template and setting of the ‘Use Print Image Matching 2/Exif Print’ option on the template selection window 80 corresponds to the shooting information-based print setting module. The layout editing management module 24 that manages the layout and editing of each selected image on the layout editing window 90 corresponds to the editing execution module.

In the print job creation apparatus 20 of the embodiment, printing in conformity with the ‘Print Image Matching 2’ standard and printing in conformity with the ‘Exif Print’ standard are given as examples of the printing with shooting information. The printing with shooting information is, however, not restricted to the ‘Print Image Matching 2’ standard or the ‘Exif Print’ standard. The technique of the invention is also applicable to any other standard that effectuates printing with information at the time of shooting.

In the print job creation apparatus 20 of the embodiment, a click of the ‘Edit’ button 92c in the selected state of a desired image on the layout editing window 90 opens a pulldown menu, which includes available editing options, that is, rotation, frame rotation, vertical or horizontal inversion, trimming, die cutting, contour softening/sharpening, settings of lightness and contrast, color change, change to sepia/monochromatic, cross filter, red eye reduction, cloning, and auto correction. Only part of these editing items may be displayed as available editing options in a pulldown menu. Other editing items may also be included in the available editing options in the pulldown menu. In any case, execution of editing options, which may damage the shooting information in the process of editing the image, is to be restricted, when the check mark is entered in the checkbox ‘Use Print Image Matching 2/Exif Print’.

In the print job creation apparatus 20 of the embodiment, the checkbox ‘Use Print Image Matching 2/Exif Print’ is provided on the template selection window 80 to set execution or non-execution of printing with shooting information, simultaneously with selection of a desired template. It is, however, not necessary to set execution or non-execution of printing with shooting information, simultaneously with selection of a desired template. Execution or non-execution of printing with shooting information may be set at any timing prior to editing of the image. For example, the checkbox ‘Use Print Image Matching 2/Exif Print’ may be provided on the image registration window 70 or on the layout editing window 90. In the latter case, the user is required to enter a check mark in the checkbox ‘Use Print Image Matching 2/Exif Print’ on the layout editing window 90, prior to a click of the ‘Edit’ button 92c.

The print job creation apparatus 20 of the embodiment enables the user to select a desired print service among the various options, enlargement, digest printing, calendar printing, idea printing, postcard, photo name card, ID photo, index printing, seal printing, and label printing, on the menu window 60. These options of print services are only illustrative and not restrictive in any sense. Part of these print service options may be specified as selectable, or any print service options different from these options may be specified as selectable. These options may otherwise be combined with other print service options.

The print job creation apparatus 20 of the embodiment provides the album services and the CD writing services, in addition to the print services. The album services or the CD writing services may be omitted, when not required. The CD writing services may be replaced by writing services into other storage media, for example, flexible disks, MDs, DVDs, and flash memories.

In the print job creation apparatus 20 of the embodiment, the print job creation process has the four steps, the image registration step, the template selection step, the layout editing step, and the print step, subsequent to selection of a desired print service. This flow of the print job creation process is not restrictive in any sense and may be modified in various ways.

The print job creation apparatus 20 of the embodiment has the job interruption module 26 to interrupt creation of a print job in the middle, the job resumption module 27 to resume interrupted creation of the print job, the job output management module 28 and the job input management module 29 to output and input a print job under creation in the form of a file, and the job duplication module 30 to duplicate a print job under creation or an executed print job and start creation of a new print job of an identical print service or a different print service. Part or all of these constituents may be omitted from the print job creation apparatus.

The above description regards the details of the print job creation apparatus 20 as the preferred embodiment of the invention. The technique of the invention may also be actualized by a print job creation method that creates a print job under restrictions or non-restrictions on editing of an image, depending upon execution or non-execution of printing with shooting information. Another possible application of the invention is a program that causes the computer to function as the print job creation apparatus 20. When the computer functions as the print job creation apparatus 20 of the embodiment, the respective steps in the print job creation routine of FIG. 3 and those in the editing management routine of FIG. 7 are programmed in an appropriate programming language.

The above embodiments are to be considered in all aspects as illustrative and not restrictive. There may be many modifications, changes, and alterations without departing from the scope or sprit of the main characteristics of the present invention. All changes within the meaning and range of equivalency of the claims are therefore intended to be embraced therein.

What is claimed is:

1. A print job creation apparatus that creates a print job, said print job creation apparatus comprising:
an image acquisition module that acquires an image, which is involved in a print job;
a shooting information-based print setting module that sets either execution or non-execution of shooting information-based printing, which represents printing with shooting information set at a time of shooting an image; and
an editing execution module that executes editing in response to an operator's operation under restrictions on a predetermined editing item among available editing items of the image involved in the print job in the case of setting execution of the shooting information-based printing by said shooting information-based print setting module, and with permission to all the available editing items of the image involved in the print job, which include the predetermined editing item, in the case of setting non-execution of the shooting information-based printing by said shooting information-based print setting module.

2. A print job creation apparatus in accordance with claim 1, wherein said shooting information-based print setting module sets execution or non-execution of the shooting information-based printing in the course of selecting a template used for printing.

3. A print job creation apparatus in accordance with claim 1, wherein the shooting information includes at least part of specification of a color space, setting of contrast, setting of saturation, setting of color balance, and setting of a shooting mode in both a shooting device and in a printing device.

4. A print job creation apparatus in accordance with claim 1, wherein said shooting information-based print setting module sets execution or non-execution of printing in conformity with PIM ‘Print Image Matching’ as the shooting information-based printing.

5. A print job creation apparatus in accordance with claim 4, wherein said shooting information-based print setting module sets execution or non-execution of printing in conformity with Exif Print ‘Exchangeable image file format Print’ as the shooting information-based printing.

6. A print job creation apparatus in accordance with claim 1, wherein said shooting information-based print setting module sets execution or non-execution of printing in conformity with Exif Print ‘Exchangeable image file format Print’ as the shooting information-based printing.

7. A print job creation apparatus in accordance with claim 1, wherein the predetermined editing item includes at least part of contour softening/sharpening, setting of lightness, setting of contrast, color change, change to sepia/monochromatic, and application of a cross filter.

8. A print job creation apparatus in accordance with claim 1, said print job creation apparatus further comprising:
a print service setting module that sets one print service selected among multiple print service options, in response to the operator's operation.

9. A print job creation apparatus in accordance with claim 8, wherein the multiple print services include at least one of an enlargement printing service, a digest printing service, a calendar printing service, a postcard printing service, a photo name card printing service, an ID photograph printing service, a seal printing service, a label printing service, and an album printing service.

10. A print job creation apparatus in accordance with claim 1, said print job creation apparatus further comprising:
a printing condition setting module that sets a printing condition of the print job, in response to the operator's operation.

11. A print job creation method that creates a print job, said print job creation method comprising the steps of:
(a) acquiring an image, which is involved in a print job;
(b) setting either execution or non-execution of shooting information-based printing, which represents printing with shooting information set at a time of shooting an image; and
(c) executing editing in response to an operator's operation under restrictions on a predetermined editing item among available editing items of the image involved in the print job in the case of setting execution of the shooting information-based printing, and with permission to all the available editing items of the image involved in the print job, which include the predetermined editing item, in the case of setting non-execution of the shooting information-based printing.

12. A print job creation method in accordance with claim 11, wherein said step (b) sets execution or non-execution of the shooting information-based printing in the course of selecting a template used for printing.

13. A print job creation method in accordance with claim 11, wherein the shooting information includes at least part of specification of a color space, setting of contrast, setting of saturation, setting of color balance, and setting of a shooting mode in both a shooting device and in a printing device.

14. A print job creation method in accordance with claim 11, wherein said step (b) sets execution or non-execution of printing in conformity with PIM ‘Print Image Matching’ as the shooting information-based printing.

15. A print job creation method in accordance with claim 14, wherein said shooting information-based print setting module sets execution or non-execution of printing in conformity with Exif Print ‘Exchangeable image file format Print’ as the shooting information-based printing.

16. A print job creation method in accordance with claim 11, wherein said step(b) sets execution or non-execution of printing in conformity with Exif Print ‘Exchangeable image file format Print’ as the shooting information-based printing.

17. A print job creation method in accordance with claim 11, wherein the predetermined editing item includes at least part of contour softening/sharpening, setting of lightness, setting of contrast, color change, change to sepia/monochromatic, and application of a cross filter.

18. A print job creation method in accordance with claim 11, said print job creation method further comprising the step of setting one print service selected among multiple print service options, in response to the operator's operation, prior to at least said step (b).

19. A print job creation method in accordance with claim 18, wherein the multiple print services include at least one of an enlargement printing service, a digest printing service, a calendar printing service, a postcard printing service, a photo name card printing service, an ID photograph printing service, a seal printing service, a label printing service, and an album printing service.

20. A print job creation method in accordance with claim 11, said print job creation method further comprising the step of setting a printing condition of the print job, in response to the operator's operation.
